(19) United States
(12) Patent Application Publication
(10) Pub. No.: US 2020/0196572 A1
(43) Pub. Date: Jun. 25, 2020

(54) ANIMAL FOOTWEAR

(71) Applicant: 2nd Skin Paw Protector, LLC, Phoenix, AZ (US)

(72) Inventor: Kui Mi Oh, Phoenix, AZ (US)

(73) Assignee: 2nd Skin Paw Protector, LLC, Phoenix, AZ (US)

(21) Appl. No.: 16/723,879

(22) Filed: Dec. 20, 2019

Related U.S. Application Data
(60) Provisional application No. 62/784,087, filed on Dec. 21, 2018.

(51) Int. Cl. A01K 13/00

(52) U.S. Cl. CPC A01K 13/007

(57) ABSTRACT

Footwear configured to be worn by an animal is provided herein. The footwear comprises a covering coupled to a footbed so as to define a pocket therebetween, wherein the pocket is configured to receive a foot of the animal, and at least one wrapping member coupled to the footbed, wherein the wrapping member is configured to wrap around a leg of the animal.

### CROSS-REFERENCE TO RELATED APPLICATION

This application claims priority to U.S. Provisional Patent Application Ser. No. 62/784,087, entitled “ANIMAL FOOTWEAR,” filed on Dec. 21, 2018 which is incorporated herein by reference in its entirety for all purposes.

### FIELD

The present disclosure relates generally to coverings for animal feet, and more particularly to footwear worn by dogs to protect their feet from hot, cold, wet, rugged and slippery surfaces.

### BACKGROUND

Placing footwear on pets may be highly desirable for protective, health, and aesthetic reasons. Pet footwear has become increasingly popular over the past few decades. Pet footwear has been predominantly used for dogs but is also contemplated for cats and other domesticated animals.

Pet footwear may be useful to mitigate discomfort that pets experience when standing, walking or running on certain surfaces, such as rough surfaces or excessively hot or cold surfaces. Specifically, hot asphalt, rough terrain, and areas with broken glass, nails, or other debris may cause discomfort or injury to the feet of animals. Rough terrain, for example, can cut or wear out the feet or pads of dogs. In other cases, it may not be safe for pets to traverse the ground when temperatures are particularly severe, such as in hot climates where the ground surface may be scorching or in colder climates where the ground may be frozen or icy. Pet footwear may also be useful to improve traction between a pet's foot and the ground, for example, on slippery or unstable surfaces such as ice, snow, sand, or wet surfaces.

Pet footwear may be desirable for other reasons. Pet footwear may be used when a pet has injured one or more paws. In such case, suitable footwear may help to protect the affected paw until sufficient healing has occurred. Pet footwear may be desired for fashion purposes and/or to prevent soiling of indoor floors when the pet returns from a walk. For example, in inclement weather, a person may not wish to clean a dog's paws after the dog has been outside. To keep floors clean, placing footwear on a pet may be easier and/or less costly than thoroughly cleaning the pet's feet and/or indoor surfaces.

Conventional pet footwear designs may not provide adequate durability to sufficiently protect a dog's paws from sharp objects on the ground, such as broken glass. Further, in instances where a pet is walking on hot pavement, many conventional pet footwear designs may not be configured to keep the pet's paws cool. Instead, many designs may trap heat within the footwear, thereby preventing the pet's paw from perspiring and/or keeping cool. Finally, many conventional pet footwear designs do not properly fit animal paws and legs. As a result, footwear may be difficult to put on the pet's foot. Once on, the footwear may not stay on well. For example, conventional pet footwear may spin about the pet's ankle, diminishing the footwear's efficacy and potentially causing discomfort or injury to the pet. Other designs may disengage from the pet's paw as the pet walks or runs. There is a need, therefore, to provide a durable, breathable, and ergonomic pet footwear.

### SUMMARY

In various embodiments, the present disclosure is directed to footwear configured to be worn by an animal, the footwear comprising a covering coupled to a footbed so as to define a pocket therebetween, wherein the pocket is configured to receive a foot of the animal, and at least one wrapping member coupled to the footbed, wherein the wrapping member is configured to wrap around a leg of the animal.

In various embodiments, the wrapping member comprises a first extension and further comprises a second extension configured to wrap over the covering and couple with the first extension, and a third extension configured to wrap over the covering and couple with the first extension. In various embodiments, the covering comprises a stretchable band disposed between the first attachment and the second attachment of the covering. In various embodiments, the foot side of the first extension is configured to couple with a ground side of the first extension by at least one of magnets or a hook and loop configuration. In various embodiments, the second extension is configured to couple with the first extension by at least one of magnets or a hook and loop configuration. In various embodiments, the third extension is configured to couple with the first extension by at least one of magnets or a hook and loop configuration.

In various embodiments, the wrapping member comprises a mesh fabric. In various embodiments, the first extension comprises a different length than the second extension and the third extension. In various embodiments, the second extension and the third extension comprise the same length. In various embodiments, the second extension comprises a different length than the third extension. In various embodiments, the footwear comprises a lightweight, breathable, and stretchable material. In various embodiments, the pocket comprises a length of between about 30 to about 90 millimeters between the first attachment and the second attachment. In various embodiments, the covering comprises a reflective material. In various embodiments, the covering comprises a metallic foil material. In various embodiments, the covering comprises a toe bumper configured to provide support and to the foot of the animal.

In various embodiments, the footwear further comprises a sole coupled to a ground side of the footwear. In various embodiments, the sole comprises a plurality of apertures extending through the sole. In various embodiments, the sole comprises neoprene, and wherein a silicone outer layer is coupled to the sole. In various embodiments, the sole comprises rubber.

In various embodiments, the present disclosure is directed to a method of using footwear configured to be worn by an animal, the method comprising inserting a foot of the animal into a pocket defined between a footbed and a covering coupled to the footbed, wrapping a first extension of the footwear around a leg of the animal, wrapping a second extension of the footwear over the pocket and coupling the second extension to the first extension, and wrapping a third extension over the pocket and coupling the third extension to the first extension.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1 illustrates an animal wearing footwear, in accordance with various embodiments;

FIG. 2 illustrates a front view of footwear in an unwrapped configuration, which is configured to be worn by an animal, in accordance with various embodiments;

FIG. 3 illustrates a back view of footwear in an unwrapped configuration, which is configured to be worn by an animal, in accordance with various embodiments;

FIG. 4 illustrates a cross-section view of Section A-A of FIG. 2, in accordance with various embodiments;

FIG. 5 illustrates an exploded front view of footwear configured to be worn by an animal, in accordance with various embodiments;

FIG. 6 illustrates an exploded back view of footwear configured to be worn by an animal, in accordance with various embodiments;

FIG. 7A illustrates a front view of footwear as worn by an animal, in accordance with various embodiments;

FIG. 7B illustrates a back view of footwear as worn by an animal, in accordance with various embodiments;

FIGS. 7C and 7D illustrate side views of footwear as worn by an animal, in accordance with various embodiments;

FIG. 7E illustrates a top view of footwear as worn by an animal, in accordance with various embodiments;

FIG. 7F illustrates a bottom view of footwear as worn by an animal, in accordance with various embodiments; and

FIG. 8 illustrates a method of using footwear, in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Surface shading lines may be used throughout the figures to denote different parts but not necessarily to denote the same or different materials. In some cases, reference coordinates may be specific to each figure.

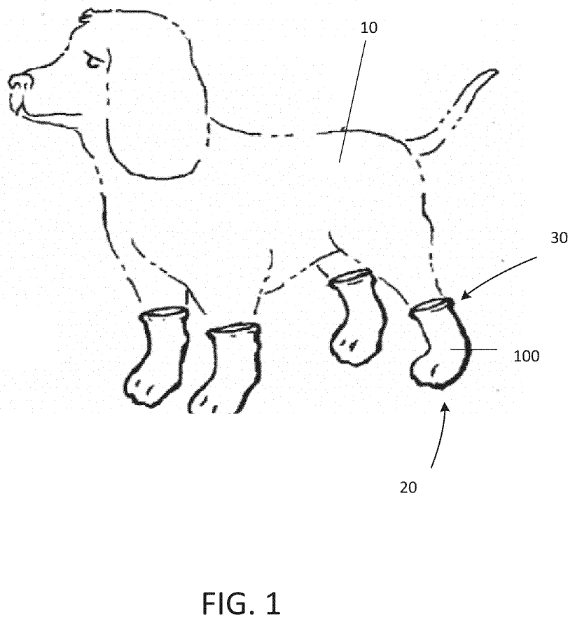

In various embodiments, and with reference to FIG. 1, footwear 100 that is configured to be worn by an animal 10 is provided. Footwear 100 may be configured to cover and protect a foot 20 of animal 10 such that it may securely surround a portion of foot 20 of animal 10. Footwear 100 may be secured about foot 20 by one or more portions of footwear 100 wrapping over a paw of animal 10 and/or wrapping around an ankle of animal 10. Footwear 100 may be configured to contour to foot 20 of animal 10. Footwear 100 may be configured to ergonomically interact with a paw, ankle, and/or foot 20, when animal 10 is at rest, bearing weight on foot 20, and/or moving. Footwear 100 may be configured to be lightweight, breathable, and/or stretchable to accommodate use in a variety of environments and/or by a variety of animals.

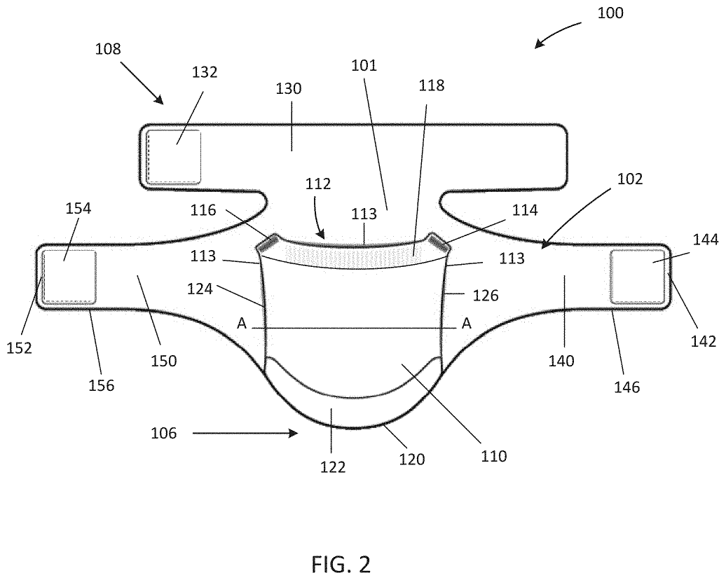

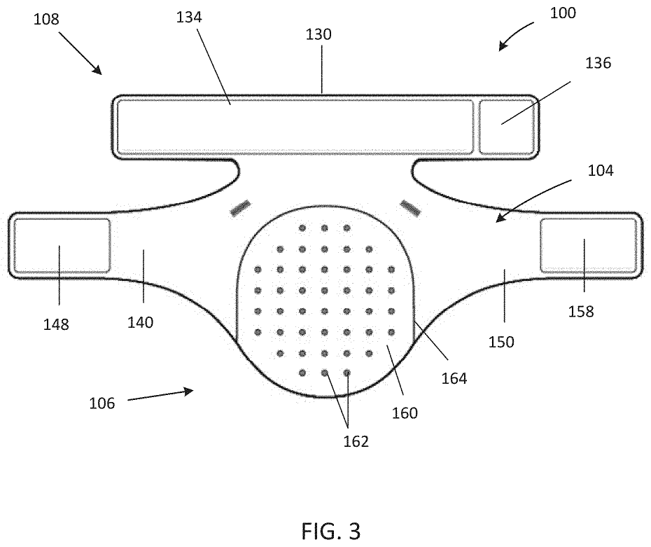

Referring to FIGS. 2 and 3, footwear 100 may comprise a footbed 101, and at least one wrapping member coupled to the footbed. In various embodiments, footbed 101 comprises a foot side 102 (with reference to FIG. 2), and a ground side 104 (with reference to FIG. 3) that is disposed opposite foot side 102. In various embodiments, foot side 102 of footwear 100 is configured to be in contact with the foot 20 of animal 10. In various embodiments, ground side 104 of footwear 100 may be configured to be in contact with the ground when footwear 100 is in use (e.g., when animal 10 is standing or walking with footwear 100 secured on foot 20). Footwear 100 may comprise a first end 106 configured to be disposed at or near the toes and/or claws at the forward end of foot 20. Footwear 100 may comprise a second end 108 disposed opposite of first end 106 and configured to be disposed at or near the rearward end of a metatarsal and/or metacarpal pad of animal 10.

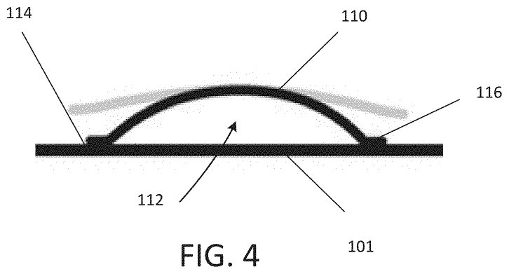

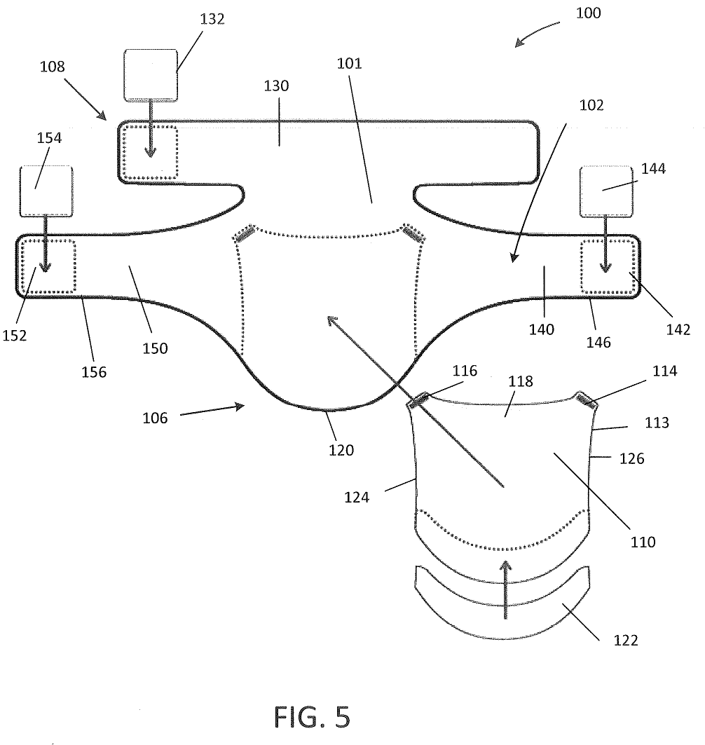

In various embodiments, referring to FIGS. 2 and 5, a covering 110 may be coupled to foot side 102 of footwear 100 so as to define a pocket 112 therebetween. In various embodiments, covering 110 may be coupled with or formed integral with foot side 102 of footwear 100. In various embodiments, covering 110 comprises a perimeter 113. The perimeter 113 may be coupled to foot side 102 at one or more points. In various embodiments, covering 110 is coupled to foot side 102 continuously around at least 50% of the perimeter 113, and is not coupled to foot side 102 at a portion of the perimeter 113 at or near second end 108, such that an opening to pocket 112 is formed. In various embodiments, covering 110 is coupled to foot side 102 continuously around at least 75% of the perimeter 113. However, in various embodiments, covering 110 is coupled to foot side 102 continuously around any portion of the perimeter 113 suitable to form an opening to pocket 112 suitable for receiving an animal foot. In various embodiments, and with reference to FIG. 4, a spring pocket pattern may be used to increase the volume comprising pocket 112. In various embodiments, pocket 112 may comprise a reflective material. In various embodiments, pocket 112 may comprise a foil metallic material.

Referring back to FIGS. 2 and 5, covering 110 may be coupled to foot side 102 at non-continuous attachment points. In various embodiments, the perimeter of covering 110 is coupled to foot side 102 at a first attachment 114 and a second attachment 116 such that foot 20 can be inserted into pocket 112 between first attachment 114 and second attachment 116. In various embodiments, at least one of first attachment 114 and second attachment 116 may be coupled to footbed 101 via bar tack stitches. In various embodiments, the perimeter 113 of covering 110 is coupled to foot side 102 at more than two non-continuous attachment points.

In various embodiments, covering 110 comprises the same material as foot side 102. In various embodiments, covering comprises different material as foot side 102. In various embodiments, covering 110 comprises one or more lightweight, breathable, stretchable, soft, washable, and/or wicking materials, or any other material suitable for use in footwear 100.

In various embodiments, covering 110 may comprise a band 118 between first attachment 114 and second attachment 116. Band 118 may be stretchable, cinchable, and/or may otherwise allow covering 110 to expand away from foot side 102 of footwear 100 to allow for the insertion of a pet foot of various sizes into pocket 112. Stretchable band 118 may comprise an elastic material. However, stretchable band 118 may comprise any material suitable for use in footwear 100.

Covering 110 may be coupled with foot side 102 at a third attachment 120 located at or near first end 106 of footwear 100. The coupling of covering 110 to foot side 102 at third attachment 120 may correspond to the position limiting toes of animal 10 in pocket 112. Stated another way, foot 20 of animal 10 may be placed in pocket 112 between first attachment 114 and second attachment 116 and extend until the toes of animal 10 meet the third attachment 120.

In various embodiments, footwear 100 may comprise a toe bumper 122. Toe bumper 122 may comprise a rubber, fabric, or other material configured to provide support and security to foot 20 of animal 10 while in pocket 112. Toe bumper 122 may also be configured to protect the toes and/or claws on foot 20 of animal 10 while footwear 100 is in use. For example, while in use over rocky terrain, toe bumper 122 may provide cushioning, impact resistance, or other protection if an animal 10 hits its foot 20 or stubs its toe on an object.

Covering 110 may comprise a first edge 124 disposed between first attachment 114 and third attachment 120. Covering 110 may also comprise second edge 126 disposed between second attachment 116 and third attachment 120. In various embodiments, at least one of first edge 124 or second edge 126 may be coupled with foot side 102. In various embodiments, first edge 124 and/or second edge 126 may be separate from and not secured to foot side 102, creating vents therebetween. Vents may be configured to increase the breathability of the footwear 100 and to keep foot 20 of animal 10 cool while in use. In various embodiments, non-continuous attachment of covering 110 to foot side 102 between any two attachment points may create vents between covering 110 and foot side 102 such that footwear 100 allows air, fluid, and/or heat circulation around foot 20 of animal 10.

Footwear 100 may further comprise one or more wrapping members configured to wrap around a portion of the animal's paw and/or leg, including without limitation those portions adjacent to the animal's claws, phalanges, metatarsal bones, and metacarpal bones. Wrapping members may be configured to secure footwear 100 on foot 20 of animal 10. Wrapping members may be configured to secure footbed 101 substantially between exterior surfaces and at least one of the animal's digital pads, metatarsal pads, and/or metacarpal pads. Wrapping members may be configured to at least partially surround the digital pads, carpal pads, and/or dew claws of animal 10.

In various embodiments, a wrapping member comprises a first extension 130. First extension 130 may be configured to wrap around leg 30 of animal 10 such that the foot side 102 of first extension 130 makes contact with leg 30. In various embodiments, first extension 130 is configured to wrap around leg 30 of animal 10 above the dew claw and/or below the carpal pad. In various embodiments, first extension 130 is coupled to footbed 101 at or near second end 108. In various embodiments, first extension 130 extends in two opposite directions outwardly away from second end 108.

In various embodiments, first extension 130 is configured to be coupled to itself and/or to second end 108. First extension 130 may comprise magnets, snaps, buttons, hook and eye, and/or hook and loop portions configured to couple first extension 130 to itself. For example, foot side 102 of first extension 130 may comprise a hook portion 132 which may couple with a loop portion 134 (see FIG. 3) located on ground side 104 of first extension 130. In various embodiments, first extension 130 may comprise label 136 may be affixed to or integral with first extension 130. Label 136 may comprise a glow in the dark or reflective material.

In various embodiments, a wrapping member comprises a second extension 140. Footwear 100 may comprise second extension 140. Second extension 140 may extend outwardly from footbed 101. Second extension 140 may terminate in a tab 142. Second extension 140 may be configured to wrap over covering 110 so as to secure footwear 100 to foot 20 of animal 10 and/or to secure footbed 101 snugly to the animal's paw pads. Second extension 140 may comprise any suitable length for use in footwear 100. In various embodiments, second extension 140 comprises a suitable length such that tab 142 couples to covering 110 when second extension 140 is wrapped snugly over the top of covering 110. In various embodiments, second extension 140 comprises a suitable length such that tab 142 couples to first extension 130 when second extension 140 is wrapped snugly over the top of covering 110 and at least partially around leg 30 of animal 10. In various embodiments, second extension 140 comprises a suitable length such that tab 142 couples to itself when second extension 140 is wrapped snugly over the top of covering 110, fully around leg 30 of animal 10, and back over the top of the animal's foot or paw.

Tab 142 may comprise magnets, snaps, buttons, hook and eye, and/or hook and loop portions configured to couple tab 142 to covering 110, first extension 130, and/or second extension 140. For example, ground side 104 of tab 142 may comprise a hook portion 144 which may couple with a loop portion 134 on ground side 104 of first extension 130. Perimeter 146 of second extension 140 may comprise at least one of a stretchable material or an elastic material. In various embodiments, ground side 104 of second extension 140 may comprise loop portion 148.

In various embodiments, a wrapping member comprises a third extension 150. Footwear 100 may comprise third extension 150. Third extension 150 may extend outwardly from footbed 101 in the opposite direction from second extension 140. Third extension 150 may terminate in a tab 152. Third extension 150 may be configured to wrap over covering 110 and/or second extension 140 so as to secure footwear 100 to foot 20 of animal 10 and/or to secure footbed 101 snugly to the animal's paw pads. Third extension 150 may comprise any suitable length for use in footwear 100. In various embodiments, third extension 150 comprises a suitable length such that tab 152 couples to second extension 140 when third extension 150 is wrapped snugly over the top of second extension 140.

In various embodiments, the wrapping member may comprise a mesh fabric, including but not limited to Darlington® brand mesh fabric, United States Trademark Registration No. 1360641 owned by Darlington Fabrics Corporation. In various embodiments, the wrapping member may comprise a fabric configured with multi-directional stretch, for example, four-way stretch. However, the wrapping member may comprise any suitable fabric or material. In various embodiments, first extension 130 may be configured to be a different length than second extension 140 and third extension 150. In various embodiments, second extension 140 and third extension 150 may be configured to be the same length. In various embodiments, second extension 140 may be configured to be a different length than third extension 150.

Tab 152 may comprise magnets, snaps, buttons, hook and eye, and/or hook and loop portions configured to couple tab 152 to first extension 130 and/or second extension 140. For example, foot side 102 of tab 152 may comprise a hook portion 154 which may couple with a loop portion 134 on ground side 104 of first extension 130. Perimeter 156 of third extension 150 may comprise at least one of a stretchable material or an elastic material. In various embodiments, ground side 104 of third extension 150 may comprise loop portion 158.

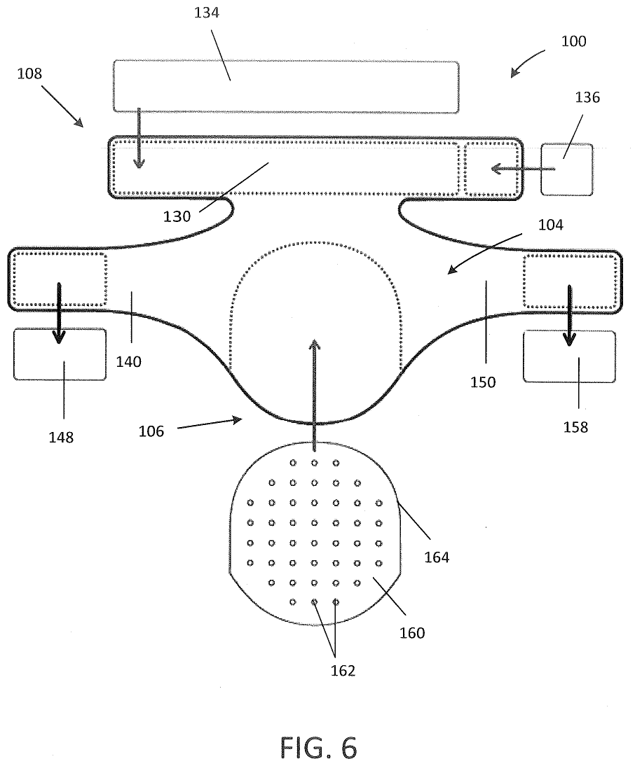

In various embodiments, and with reference to FIGS. 3 and 6, ground side 104 of footwear 100 may comprise a sole 160. Sole 160 may comprise a material configured to withstand the wear or walking or running on rugged surfaces. Sole 160 may be configured to be heat resistant and/or otherwise insulate foot 20 from hot and/or cold ground surface temperatures. In various embodiments, sole 160 is heat resistant up to about 400° C. In various embodiments, sole 160 may comprise neoprene. A silicone outer layer may be coupled to sole 160. In various embodiments, sole 160 may comprise silicone. In various embodiments, sole 160 may comprise rubber. However, sole 160 may comprise any material suitable for use in footwear 100.

Sole 160 may comprise a tread configured to increase traction and thereby prevent slipping while walking or running. Sole 160 may comprise a plurality of apertures 162 extending through sole 160 from footbed 101 to the ground. Apertures 162 may comprise various shapes and sizes. Apertures 162 may be configured to increase the breathability of footwear 100 and keep the foot 20 of animal 10 from overheating while in pocket 112. In wet conditions or water environments, apertures 162 may facilitate fluid drainage from footwear 100. Wicking properties of the portions of footwear 100 directly abutting the animal's foot, for example, footbed 101, covering 110, and/or wrapping members, may draw fluid away from the animal's foot and toward apertures 162, through which it may be drained to exterior of footwear 100.

Footwear 100 may comprise a side bumper 164 disposed at or near at least a portion of the outer perimeter of sole 160. Side bumper 164 may extend upwardly from a top surface of sole 160 so as to create a sidewall around at least a portion of sole 160. Side bumper 164 may have a uniform height or may vary in height around the outer perimeter of sole 160. In various embodiments, side bumper 164 comprises rubber. However, side bumper 164 may comprise any material suitable for use in footwear 100.

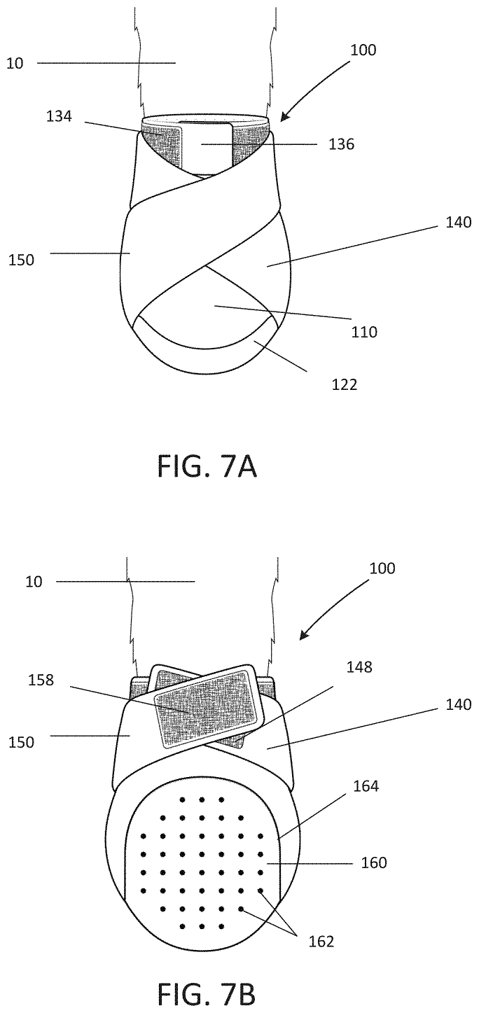

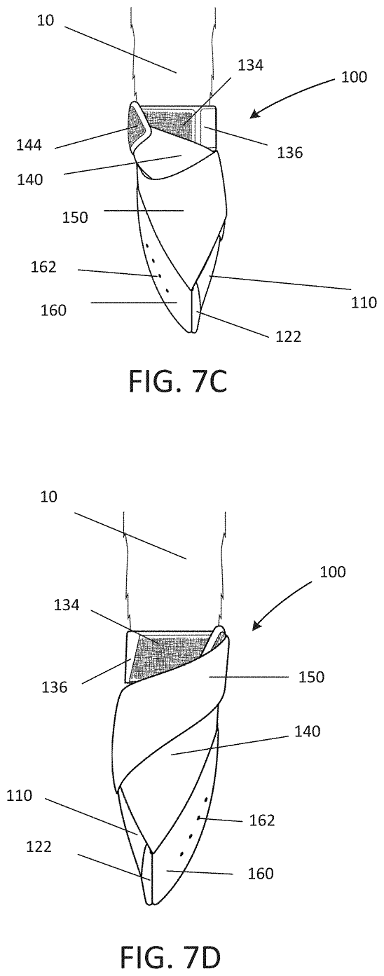

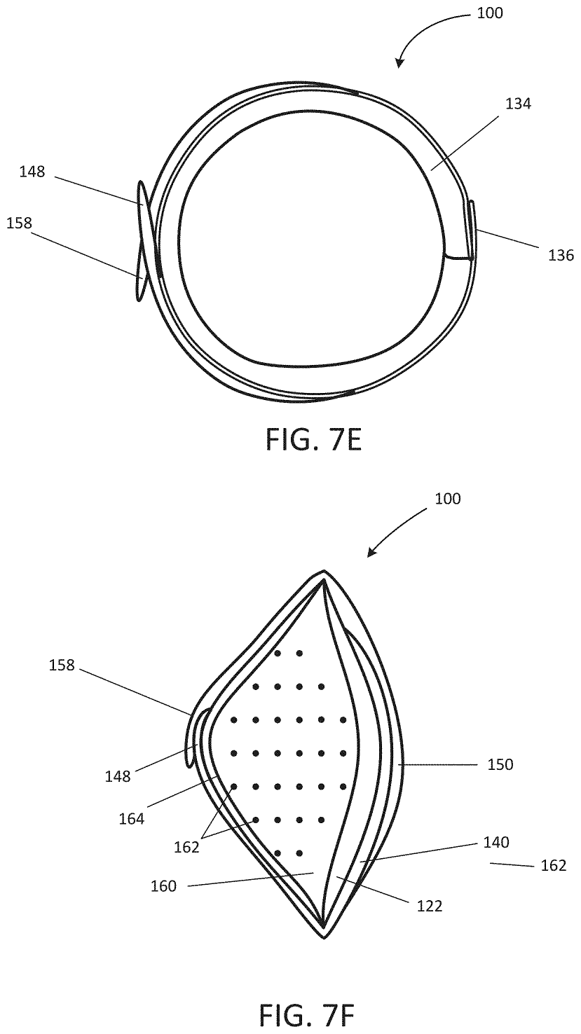

In various embodiments and with reference to FIGS. 7A-7F, footwear 100 may be configured to be worn by animal 10. Second extension 140 may wrap around covering 110 and couple with first extension 130. Hook portion 144 of second extension 140, for example, may couple with loop portion 134 of first extension 130. Thereafter, third extension 150 may wrap around second extension 140 and couple with at least one of the ground side 104 of first extension 130 or the ground side 104 of second extension 140. For example, hook portion 154 of third extension 150 may couple with at least one of loop portion 134 of first extension 130 or loop portion 148 of second extension 140.

The wrapping of second extension 140 and third extension 150 around covering 110 and coupling to first extension 130 may conform the shape of footwear 100 to the shape of foot 20, thereby increase stabilization of foot 20 of animal 10 within footwear 100. For example, for a more secure fit, at least one of the second extension 140 or third extension 150 may be wrapped tightly around covering 110. Due to the increased stability of foot 20 of animal 10 in footwear 100, relative movement between footwear 100 and foot 20 of animal 10 may be prevented or decreased while footwear 100 is in use. In various embodiments, decreased or prevented relative movement between footwear 100 and foot 20 may improve comfort of footwear 100 for the animal 10, improve wicking of moisture through footwear 100 and away from foot 20, and/or prevent or decrease the risk that foot 20 will develop blisters or sores during use.

In various embodiments, footwear 100 may be configured to fit a foot 20 of various sizes. For example, footwear 100 may comprise a pocket 112, one or more wrapping members, or a sole 160 having various dimensions. In various embodiments, pocket 112 comprises a length of between about 30 to about 45 millimeters (wherein about means +/−15 mm) between first attachment 114 and second attachment 116. In various embodiments, pocket 112 comprises a length of between about 45 to about 60 millimeters (wherein about means +/−15 mm) between first attachment 114 and second attachment 116. In various embodiments, pocket 112 comprises a length of between about 60 to about 75 millimeters (wherein about means +/−15 mm) between first attachment 114 and second attachment 116. In various embodiments, pocket 112 comprises a length of between about 75 to about 90 millimeters (wherein about means +/−15 mm) between first attachment 114 and second attachment 116. However, footwear 100 and/or its constitutive elements may comprise any suitable size for inserting a foot 20 of animal 10 into pocket 112.

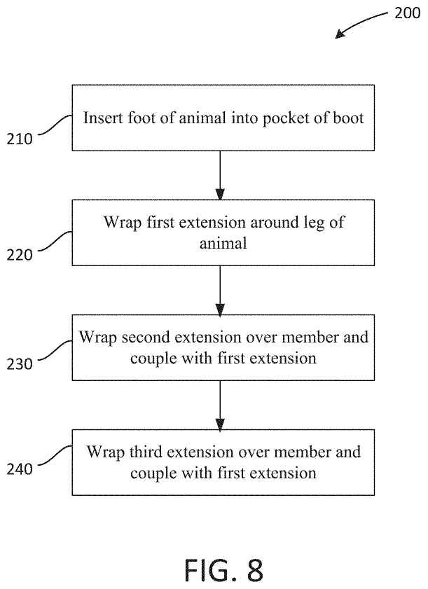

In various embodiments, referring to FIG. 8, a method 200 of using a footwear 100 is provided. The method may comprise inserting a foot 20 of animal 10 into pocket 112 of the footwear 100 (step 210). The method may further comprise engaging a wrapping member around leg 30 of the animal 10. The wrapping member may comprise a first extension 130 (step 220). The wrapping member may comprise a second extension 140. The wrapping member may comprise a third extension 150. The method may further include wrapping the second extension 140 over the pocket 112 and coupling the second extension 140 to the first extension 130 (step 230). The method may further include wrapping the third extension 150 over the pocket 112 and coupling the third extension 150 to the first extension 130 (step 240). Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. Footwear configured to be worn by an animal, comprising:
a covering coupled to a footbed so as to define a pocket therebetween, wherein the pocket is configured to receive a foot of the animal; and
at least one wrapping member coupled to the footbed, wherein the wrapping member is configured to wrap around a leg of the animal.

2. The footwear of claim 1, wherein the wrapping member comprises a first extension and further comprising:
a second extension configured to wrap over the covering and couple with the first extension; and
a third extension configured to wrap over the covering and couple with the first extension.

3. The footwear of claim 2, wherein the foot side of the first extension is configured to couple with a ground side of the first extension by at least one of magnets or a hook and loop configuration.

4. The footwear of claim 2, wherein the second extension is configured to couple with the first extension by at least one of magnets or a hook and loop configuration.

5. The footwear of claim 2, wherein the third extension is configured to couple with the first extension by at least one of magnets or a hook and loop configuration.

6. The footwear of claim 2, wherein the wrapping member comprises a mesh fabric.

7. The footwear of claim 2, wherein the first extension comprises a different length than the second extension and the third extension.

8. The footwear of claim 2, wherein the second extension and the third extension comprise the same length.

9. The footwear of claim 2, wherein the second extension comprises a different length than the third extension.

10. The footwear of claim 2, wherein the footwear comprises a lightweight, breathable, and stretchable material.

11. The footwear of claim 2, wherein the covering comprises a reflective material.

12. The footwear of claim 2, wherein the covering comprises a metallic foil material.

13. The footwear of claim 2, wherein the covering comprises a stretchable band disposed between a first attachment and a second attachment of the covering.

14. The footwear of claim 13, wherein the pocket comprises a length of between about 30 to about 90 millimeters between the first attachment and the second attachment.

15. The footwear of claim 1, wherein the covering comprises a toe bumper configured to provide support and to the foot of the animal.

16. The footwear of claim 1, further comprising a sole coupled to a ground side of the footwear.

17. The footwear of claim 16, wherein the sole comprises a plurality of apertures extending through the sole.

18. The footwear of claim 16, wherein the sole comprises neoprene, and wherein a silicone outer layer is coupled to the sole.

19. The footwear of claim 16, wherein the sole comprises rubber.

20. A method of using footwear configured to be worn by an animal, the method comprising:
inserting a foot of the animal into a pocket defined between a footbed and a covering coupled to the footbed;
wrapping a first extension of the footwear around a leg of the animal;
wrapping a second extension of the footwear over the pocket and coupling the second extension to the first extension; and
wrapping a third extension over the pocket and coupling the third extension to the first extension.
